(19) United States
(12) Patent Application Publication
(10) Pub. No.: US 2003/0231358 A1
(43) Pub. Date: Dec. 18, 2003

(54) System and method for automatically feeding documents to a scanning device

(76) Inventors: William Robert Haas, Fort Collins, CO (US); Kirk Steven Tecu, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/159,091

(22) Filed: May 30, 2002

(51) Int. Cl. H04N 1/04

(52) U.S. Cl. 358/498; 358/474

(57) ABSTRACT

A method of feeding a document to be scanned to a scanning device from a document feed device comprising picking a document from an input support, driving the document through traversal of a first portion of a feed path defined by a first guide, the document comprising an anterior edge, a posterior edge, and an intermediate portion therebetween, traversing, by the anterior edge, a scan region defined by an opening in the feed device optically coupled with the scanning device, the document traversing the scan region without impinging a plane of the opening, impinging the anterior edge with a second guide, and driving the document through traversal of a second portion of the feed path defined by the second guide is provided.

### TECHNICAL FIELD OF THE INVENTION

This invention relates to imaging systems and, more particularly, to a system and method for feeding documents to a scanning device.

### BACKGROUND OF THE INVENTION

Document scanners convert a visible image on a document, photograph, a transparent media and the like into an electronic form suitable for copying, storing and processing by a computer. A document scanner may be a stand-alone device or integrated with a copier, a facsimile machine, a multipurpose device, etc.

Flat bed scanners are stationary devices which have a transparent plate or platen upon which an object to be scanned, such as a paper document, is placed. The document is scanned by sequentially imaging narrow strips, or scan line portions, of the document on a linear optical sensor array such as a charge coupled device (CCD). The optical sensor array produces electronic data which is representative of each scan line portion of the document which is imaged thereon.

In one type of flat bed scanner, the current scan line portion of the document which is imaged on the sensor array is changed, or “swept”, by moving the platen supporting the document relative to the scanner imaging assembly. In another type of flat bed scanner, the platen and document remains stationary and at least a portion of a imaging assembly is moved to change the scan line portion which is currently imaged. Flat bed scanners of the second type are sometimes provided with automatic document feeders (ADFs) integrated within a scanner cover which sequentially move sheet documents across a portion of the scanner platen. When an ADF is used, the portion of the imaging assembly which ordinarily moves during scanning remains stationary and relative movement between the document and imaging assembly is provided by the ADF. However, conventional ADFs utilize a window, or other transparent panel, for providing a scan region through which scan lines of an image are made. The window of an ADF has a propensity to become deteriorated, soiled, scratched, or otherwise damaged such that the translucence thereof is decreased. The scanned image quality of documents imaged during passage of an ADF window deteriorates in relation to the loss of translucence of the window.

### SUMMARY OF THE INVENTION

In accordance with an embodiment of the present invention, a device for feeding documents to be scanned to a scanning device comprising a device chassis having an elongate opening aligned along a transverse axis of the device, the elongate opening disposed on a bottom surface of the device chassis and adjacent a platen surface when the device is positioned for performing a scan operation, a first guide that provides at least a portion of a document feed path, the first guide comprising a first surface defining a first vertex, a second guide that provides at least a portion of the document feed path, the second guide comprising a second surface defining a second vertex, the first vertex disposed at a greater distance than the second vertex relative to the platen surface, and an imaging roller rotationally operable to engage a document and drive the document past the elongate opening into impingement with the second guide, the document having an anterior edge that is driven past the first vertex prior to traversing the second vertex and impinging with the second guide, the imaging roller imparting the document with a sufficient trajectory such that the anterior edge does not impinge the platen surface is provided.

In accordance with another embodiment of the present invention, a method of feeding a document to be scanned to a scanning device from a document feed device comprising picking a document from an input support, driving the document through traversal of a first portion of a feed path defined by a first guide, the document comprising an anterior edge, a posterior edge, and an intermediate portion therebetween, traversing, by the anterior edge, a scan region defined by an opening in the feed device optically coupled with the scanning device, the document traversing the scan region without impinging a plane of the opening, impinging the anterior edge with a second guide, and driving the document through traversal of a second portion of the feed path defined by the second guide is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a perspective view of a document scanner system connected to a computer in which an embodiment of the present invention could be employed to advantage;

FIG. 2 is a cross-sectional side view of reflective scanner in a configuration for scanning an image on an opaque media in which an embodiment of the present invention could be employed to advantage;

FIG. 3 is a simplified perspective diagram of an automatic document feeder that may be used for scanning one or more documents on a scanner device in which an embodiment of the present invention could be employed to advantage;

FIG. 4 is a schematic side cross-sectional view of the automatic document feeder according to the prior art;

FIG. 5 is a schematic of a drive mechanism that employs a direct current motor and a transmission to drive a shaft on which a top feed roller is mounted via a gear according to the prior art;

FIG. 6 is a schematic side cross-sectional view of an automatic document feeder and a reflective scanner in a configuration for sequentially scanning a plurality of documents according to the prior art;

FIGS. 7A and 7B are, respectively, a simplified cross-sectional schematic of a document scanner and an automatic document feeder integrated within a scanner cover in which an embodiment of the present invention may be employed to advantage;

FIG. 8A is a schematic side-view of a feed roller and an imaging roller in a configuration according to an embodiment of the present invention;

FIG. 8B is a schematic side-view of the feed roller and imaging roller of FIG. 8A after passage of an anterior edge of a document through a scan region according to an embodiment of the present invention;

FIG. 8C is a schematic side-view of the feed roller and imaging roller of FIGS. 8A and 8B with the imaging roller repositioned to facilitate scanning of a document according to an embodiment of the present invention;

FIG. 8D is a schematic top-view of the feed roller and imaging roller of FIGS. 8A-8C in a configuration of the present invention;

FIG. 9 is a side sectional schematic and of an automatic document feeder having an elongate opening in a bottom surface of a chassis thereof that defines a scan region in which one or more documents may be scanned during traversal according to an embodiment of the present invention; and

FIG. 10 is a top sectional schematic of the automatic document feeder described with reference to FIG. 9 according to an embodiment of the present invention.

### DETAILED DESCRIPTION OF THE DRAWINGS

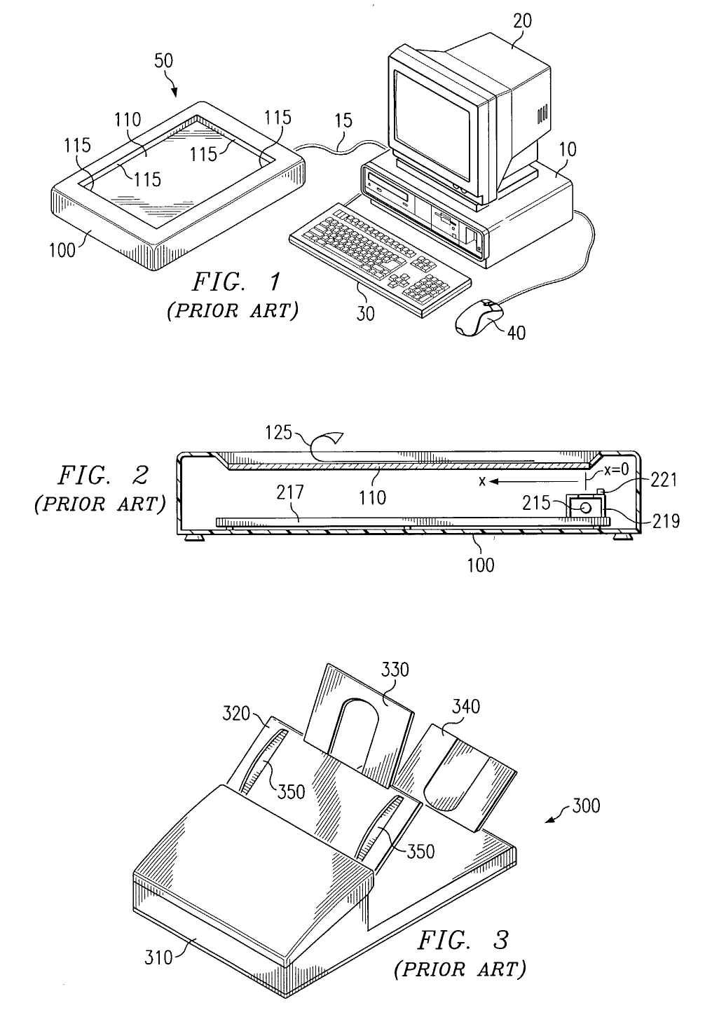

The preferred embodiment of the present invention and its advantages are best understood by referring to FIGS. 1 through 10 of the drawings, like numerals being used for like and corresponding parts of the various drawings.

In FIG. 1, there is a perspective view of a document scanner system 50 connected to a computer 10. Document scanner system 50 includes reflective scanner 100 which includes a transparent platen 110 against which the document to be scanned is placed. Computer 10 may be coupled to, and facilitate control of, document scanner system 50 via an external peripheral interface 15 such as a parallel interface, a universal serial bus interface or other communications medium. Computer 10 may include one or more input devices, such as a keyboard 30 and a mouse 40, that allow user interaction therewith and facilitate user control of scanner system 50. One or more output devices, such as a monitor 20, a printer (not shown), memory, data storage devices or another device, may allow transfer of data from the computer 10 to an external system.

FIG. 2 is a cross-sectional side view of reflective scanner 100 shown in a configuration for scanning an image on an opaque media 125. Scanner 100 includes an internal lamp 215. Lamp 215 may be attached to a carriage 219 operable to impart a linear motion of the lamp along a rail 217 or another structure. An optic system (not shown) may also be included on carriage 219 as well as a photosensitive device 221 such as an array of CCDs. Opaque media 125 is placed on platen 110 of scanner 100. As carriage 219 moves lamp 215 along the length, or a portion thereof, of rail 217, light from lamp 215 is directed onto the image on opaque media 125 through platen 110 and reflected. The reflected light is collected by an internal optic system (not shown) and directed onto photosensitive device 221 where the light is converted into one or more electric signals. Generally, carriage 219 has a home position (X=0) from which scan operations are initiated. As light is radiated from lamp 215, carriage 219 moves through a translation distance (X) along rail 217. Photosensitive device 221 converts light radiated from lamp 215 as carriage 219 moves through the distance X.

FIG. 3 is a simplified perspective diagram of an automatic document feeder (ADF) 300 that may be used for scanning one or more documents on a scanner device, such as reflective scanner 100. ADF 300, in general, comprises a chassis 310 that houses one or more feeder components and associated circuitries. Chassis 310 may comprise an input tray 320 that supports one or more document originals to be scanned by scanner 100. Input tray 320 may have an input extension 330 that supports large documents, such as 11×17 inch documents, A4 sized documents, or other large documents that may extend beyond the structure of input tray 320. Input tray 320 may have one or more document guides 350 that facilitate feeding of various width documents by ADF 300. ADF 300 may have an output tray 340 for receiving documents as they are ejected from ADF 300 upon completion of a scan.

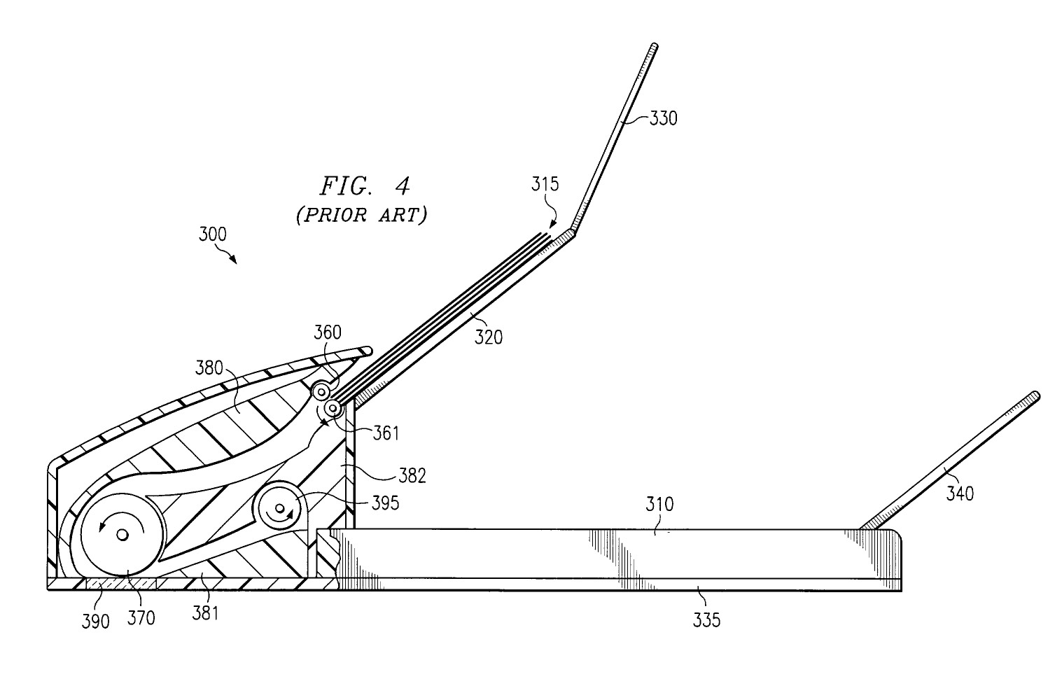

FIG. 4 is a schematic side cross-sectional view of ADF 300 with a generally flat horizontally extending table or platen surface 335 having a ADF window 390 at one end thereof through which a document to be scanned can be viewed by the scanning components of a scanning device, such as reflective scanner 100. Input tray 320 may have an inclined frame that facilitates feeding of one or more documents 315 to ADF 300. ADF 300 may have one or more paper guides 380-382 disposed in chassis 310 that define a paper path extending from input tray 320 to ADF window 390 and past a document imaging roller 370 and a document output roller 395 to a scanned document output location at which output tray 340 is preferably provided for receiving a stack of scanned documents. The apparatus for feeding individual sheets of documents 315 to a scan region provided by ADF window 390 includes input tray 320 and may include one or more upper and lower media feed rollers 360 and 361 and a suitable drive mechanism for rotating rollers 360 and 361. An output roller 395 may be disposed within chassis 310 that facilitates ejection of a scanned document into output tray 340.

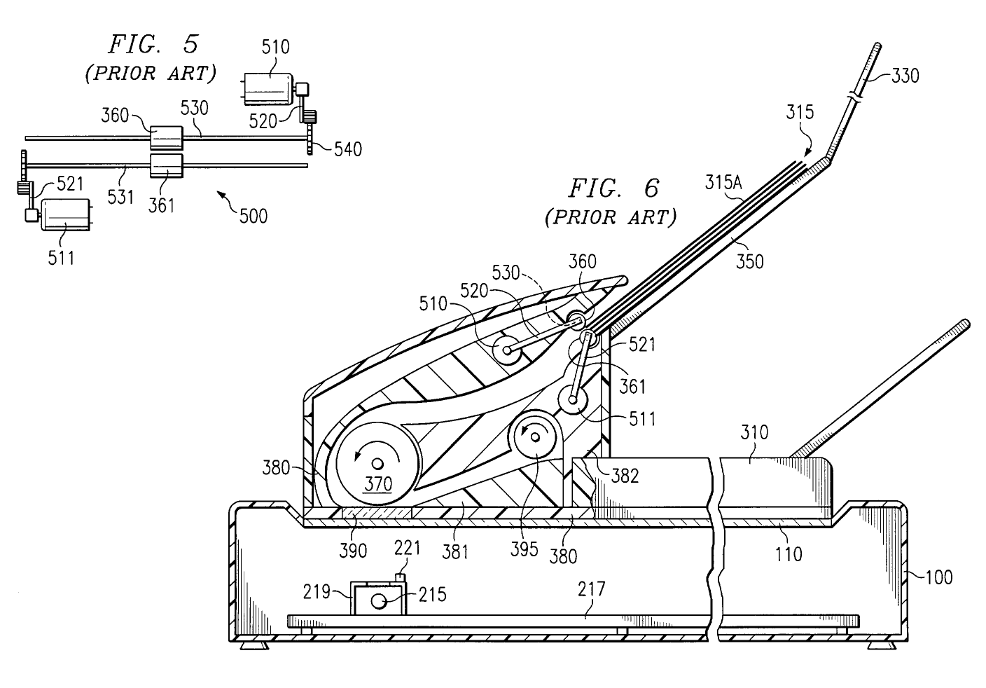

A drive mechanism for rotating rollers 360 and 361 can take any one of various forms. One form of drive mechanism 500 is schematically shown in FIG. 5 and employs a small DC motor 510 and transmission 520 to drive shaft 530 on which the top feed roller 360 is mounted via gear 540. Similarly, a second small DC motor 511 is used to drive bottom feed roller 361 which is mounted on shaft 531 through a transmission 521. Drive mechanism 500 is exemplary only and various configurations are possible. For example, a single DC motor may be employed by drive mechanism 500 for driving rollers 360 and 361. The configuration of imaging rollers 360 and 361 may be substituted with various other roller configurations as well and may employ a single driver roller or more than two imaging rollers. A similar or common drive mechanism may be employed to drive imaging roller 370 and/or output roller 395.

Modern scanning systems allow various controls and system parameters to be controlled or manipulated by a user through user interactions with software modules executed on computer 10. For example, a user interacting with computer 10 may vary exposure rates performed by reflective scanner 100 when performing a particular type of scan. Invocation of various scan controls and image processing directives are possible through computer control of scanner system 50.

To facilitate performing multiple sequential scans of a plurality of documents with reflective scanner 100, the user may provide directives that instruct reflective scanner 100 to operate in coordination with ADF 300. As mentioned hereinabove, when an ADF is used, the portion of the imaging assembly which ordinarily moves during scanning remains stationary and relative movement between the document and the imaging assembly is provided by the ADF. Accordingly, the user may provide input into a computer coupled to a reflective scanner that results in the computer directing the reflective scanner to perform a scan operation with the carriage assembly in a stationary position. Alternatively, a command to direct the scanner to perform a stationary carriage scan may be provided by ADF 300 or may be provided by an input made directly to scanner 100 itself.

FIG. 6 is a schematic side cross-sectional view of ADF 300 and reflective scanner 100 in a configuration for sequentially scanning a plurality of documents 315. Documents 315 are supported by input tray 350 such that in a normal operating position, a document 315A may be picked from documents 315 upon engagement therewith by feed rollers 360 and 361. As document 315A is picked by rollers 360 and 361, a motion is imparted thereto and the translation of document 315A is defined by one or more of guides 380 and 382 until document 315A is engaged with imaging roller 370. Document 315A is driven across ADF window 390 upon engagement with imaging roller 370. In a configuration for scanning documents automatically fed by ADF 300, carriage 219 is positioned below ADF window 390 such that light radiated from lamp 215 will pass through platen 110 and ADF window 390 and reflect from a portion of document 315A adjacent ADF window 390. The light reflected from the portion of document 315A then passes through ADF window 390 and platen 110 and thereafter may be collected by the optic system and photosensitive device 221. Thus, ADF window 390 defines a scan region through which scan lines may be sequentially imaged as document 315A is driven past ADF window 390. As document 315A is driven past ADF window 390, one or more guides 381 and 382 may direct document 315A along a path toward output tray 340. Output roller 395 may be disposed within chassis 310 and may engage document 315A such that ejection of document 315A into output tray 310 is facilitated.

As mentioned hereinabove, ADF window 390 has a propensity to become soiled, scratched, or otherwise impure such that the translucence thereof is decreased. Scanned image quality of documents 315 made by passing documents by ADF window 390 deteriorate in relation to the loss of translucence of ADF window 390.

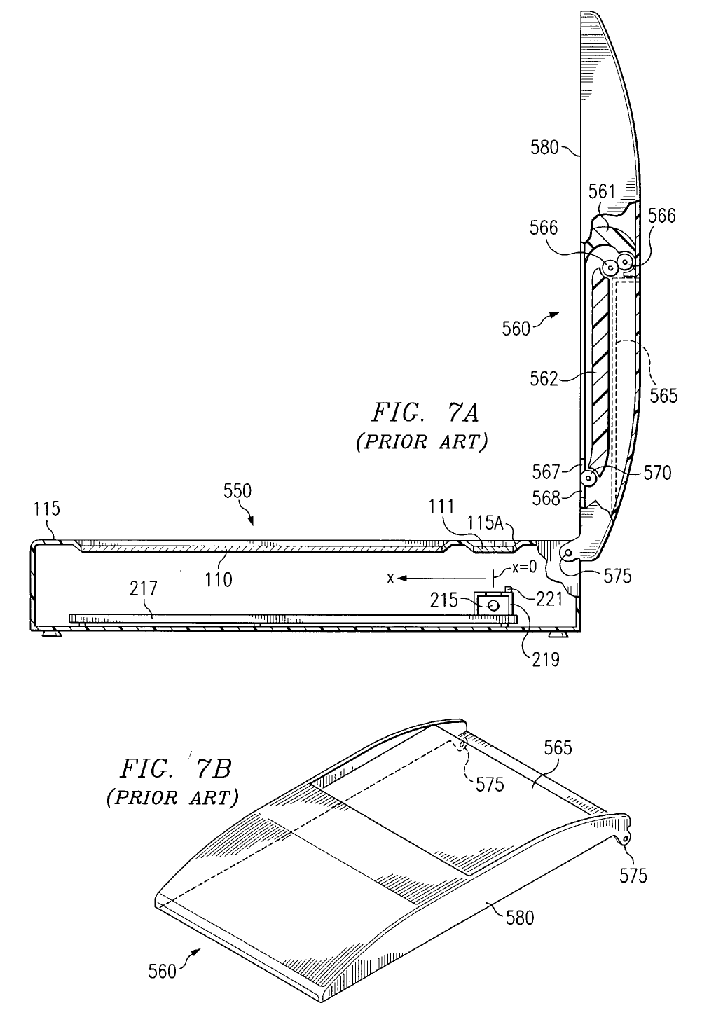

With reference now to FIGS. 7A and 7B, there is a simplified cross-sectional schematic of a conventional scanner 550 that may have an ADF integrated within a cover assembly 560 coupled therewith. A conventional ADF integrated within cover assembly may comprise one or more feed rollers and imaging rollers and one or more drive assemblies in a configuration similar to that described hereinabove with reference to FIG. 5 or in another of various configurations. Cover assembly 560 may be rotateably attachable to scanner 550 and may, accordingly, have one or more hinges 575 for removeably coupling assembly 560 with scanner 550. Scanner 550 includes internal lamp 215 attached to carriage 219 operable to impart a linear motion of the lamp along rail 217 or another structure. An optic system (not shown) may also be included on carriage 219 as well as a photosensitive device 221 such as an array of CCDs. Scanner 550 may operate in one of two general modes: scanning of a single document or scanning of multiple documents facilitated by the ADF assembly integrated within cover assembly 560. In a first operational mode, a document to be scanned is placed on platen 110 and a scan operation is thereafter initiated. In such a mode of operation, the imaging assembly, that is carriage 219 and imaging components disposed thereon, or otherwise coupled thereto, moves lamp 215 through a translation distance (X) along a length of rail 217 and light from lamp 215 is directed onto the image on the document through platen 110 and reflected. The reflected light is collected by an internal optic system and directed onto photosensitive device 221 where the light is converted into one or more electric signals. In a second operational mode, a plurality of documents, or other media to be scanned, are sequentially fed by an ADF apparatus integrated within scanner cover assembly 560. In the second operational mode, cover assembly 560 is placed in a “closed” position such that a bottom surface 580 is adjacent a top surface 115 of scanner 550. Cover assembly 560 may have a document input tray 565 for supporting a plurality of documents to be fed to scanner 550. A feed roller 566 may be rotateably engageable with a document in tray 565 and operable to pick a document from a plurality of documents supported by tray 565. One or more guides 561 and 562, or other structures, may define a document feed path through which a document is driven from input tray 565 to a scanner assembly outlet 567. A document may be driven through outlet 567 by an imaging roller, a belt-drive assembly, or another apparatus. As a document is driven through outlet 567, the document is positioned in contact with secondary scan platen 111 of scanner 550 whereupon an image portion of the document in contact therewith is scanned by the imaging assembly of scanner 550. Accordingly, when imaging documents in the second operational mode, the imaging assembly remains stationary in a home position (X=0). Sequential image scan lines are captured by the imaging assembly as the document is driven past secondary scan platen 111. As the document is driven past secondary scan platen 111, an inclined portion 115A of top surface 115 may direct the document through a cover assembly inlet 568 of cover assembly 560 and, as the document is rotateably engaged with one or more feed or imaging rollers, thereafter driven to an output tray (not shown) disposed on cover assembly 560. While such a scanner and ADF configuration does not require a platen or other transparent surface to be included within cover assembly 570, scanner 550 must be equipped with a secondary scan platen 111. Inclusion of secondary scan platen 111 increases the overall manufacturing cost of scanner 550 and undesirably increases the requisite dimensions of scanner 550. Moreover, a conventional ADF integrated within scanner cover assembly 570 has a propensity to “jam” during traversal of a scanned document through scanner assembly outlet 568.

The present invention provides an ADF with a scan region defined by an opening, rather than a window, such that no ADF element or component is disposed in the scan region. Accordingly, no ADF component may become soiled and adversely effect the scan quality of documents fed thereby to a scanning device. Furthermore, engagement of an imaging roller with a document being scanned is delayed until a portion of the document has traversed a predefined position of an output element to alleviate jamming of the document during traversal thereby past a scan region of the scanner device.

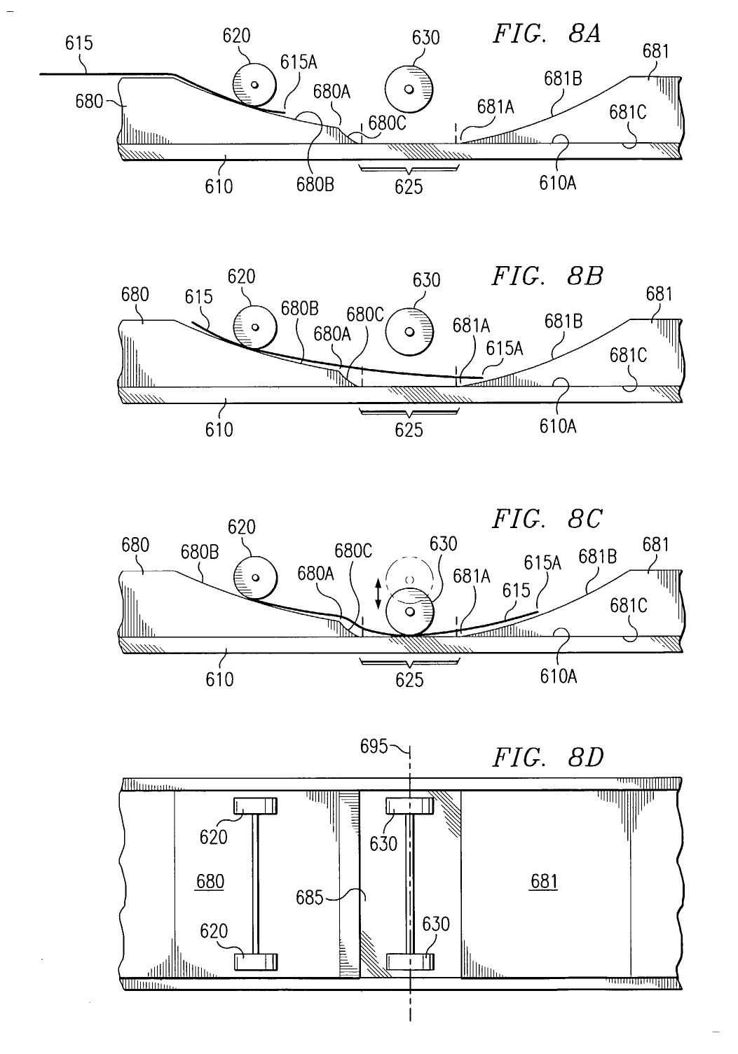

The present invention may better be understood with reference now to FIGS. 8A-8D. FIG. 8A is a schematic side view of one or more feed rollers 620 and one or more imaging rollers 630 in a configuration according to an embodiment of the present invention. One or more document guides may define a path along which a document 615 traverses when engaged with feed roller 620. Thereafter, document 615 is forwarded along a document path towards a scan region 625 defined by an opening 685 (FIG. 8D) in a bottom surface 695 of an ADF chassis or frame that is adjacent a platen 610 on which the ADF is positioned. A scanning device may be positioned beneath platen 610 in such a manner to be optically coupled with the scan region (and, thus, a document portion situated within the scan region) and may image document 615 traversing scan region 625. To facilitate proper positioning of document 615 within scan region 625 and to avert jamming of the document with a document guide, a first document guide 680 and a second document guide 681 may be configured to facilitate passage of an anterior edge 615A of document 615 past a vertex 681A (that is, a point of guide 681 generally characterized as an intersection of two surfaces 681B and 681C of guide 681) of document guide 681 prior to engagement of imaging roller 630 with document 615. Preferably, document guide 680 comprises two intersecting surfaces 680B and 680C that define a vertex 680A situated at a greater vertical disposition than vertex 681A relative to a platen surface 610A when document guides 680 and 681 are appropriately positioned adjacent platen 610 for performing a scan operation. For example, a stand-alone ADF featuring guides 680 and 681 may be considered to be in position for scanning a document when the ADF is positioned upright with a bottom surface thereof in contact with platen surface 610A. Similarly, an ADF integrated in a scanner cover assembly may be considered to be in a position for performing a scan operation when the cover assembly is in a closed position such that a bottom surface of the cover assembly is in contact with a scanner platen surface 610A. While vertices 680A and 681A illustrated are formed from intersecting surfaces of a respective guide 680 and 681, alternative configurations of guides 680 and 681 are possible without departing from the present invention. For example, a first vertex of a document guide situated at a greater vertical disposition than a vertex of a second document guide may be formed by a single surface of a document guide and another surface or structure of the ADF. Likewise, the vertex of the second document guide may be formed from intersecting surfaces of the document guide or may alternatively be formed from intersecting surfaces of two or more ADF structures or a combination of intersecting surfaces of a document guide and other ADF structures.

The relative positions of vertices 680A and 681A facilitate driving document 615 through scan region 625 in such a manner that anterior edge 615A may pass through scan region 625 and impinge guide 681 without coming in contact with platen 610 thereby avoiding a common cause of ADF jamming, as shown in a schematic side view of a feed roller 620 and an imaging roller 630 in a configuration of the present invention of FIG. 8B. In other words, anterior edge 615A traverses scan region 625 and impinges guide 681 without intersecting a longitudinal plane (co-planar with a longitudinal axis 695) of opening 685. After traversal by anterior edge 615A through scan region 625 and impingement with guide 681B, imaging roller 630 is preferably rotateably engaged with document 615 (FIG. 8C). For example, imaging roller 630 may be disposed within the ADF and may have a translational motion imparted thereto that directs imaging roller 630 into contact with document 615 and thus drives a portion of document 615 into abutment with platen 610 As described above, prior to engagement of imaging roller 630 with document 615, an anterior edge 615A has been driven past imaging roller and into impingement with guide 681. Accordingly, initial contact between imaging roller 630 and document 615 is made at an portion of document 615 intermediate anterior edge 615A and a posterior edge 615B.

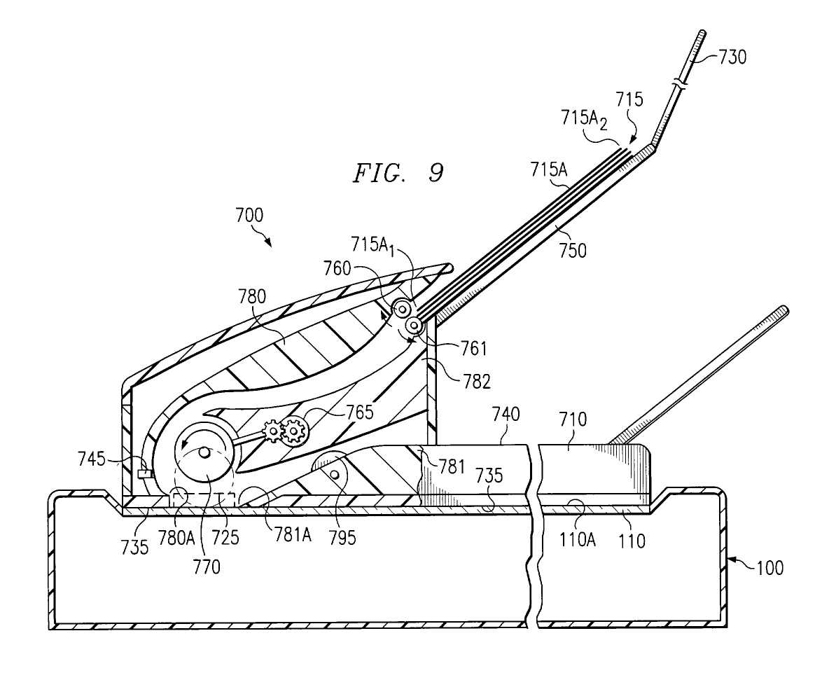

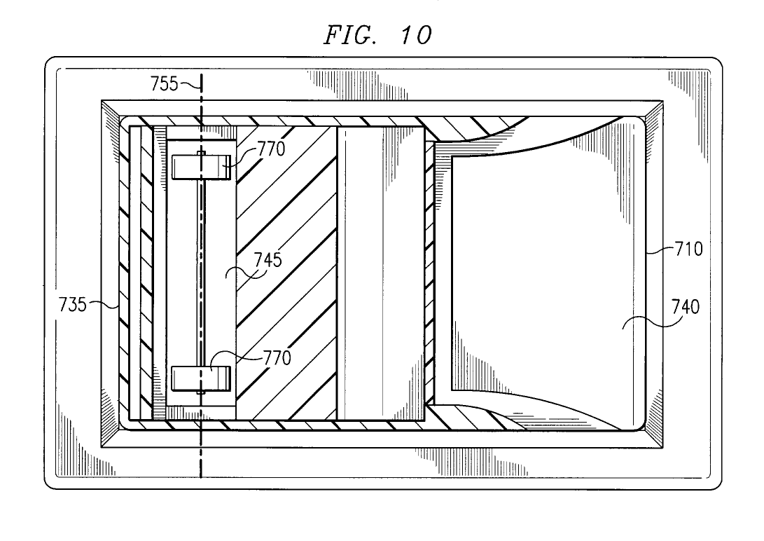

With reference now to FIGS. 9 and 10, there is respectively shown a side sectional schematic and a top sectional schematic of a stand-alone ADF 700 having an elongate opening 745 in a bottom surface 735 of a chassis 710 defining a scan region 725 in which one or more documents 715 may be scanned during traversal thereof according to an embodiment of the present invention. Scan region 725, in general, corresponds to a region adjacent elongate opening 745 when device 700 is optically coupled to a scanner device 100 such that a scan operation may be performed on a document fed to scanner device 100 by device 700. An input tray 750, or another support, may support one or more documents 715 that may be sequentially fed past scan region 725. One or more feed rollers 760 and 761, or another component for extracting a document from input tray 750, may have a rotational motion imparted thereto via one or more DC motors (not shown) or another power source. As a document 715A is engaged by feed rollers 760 and 761, a translational motion is imparted thereto that drives document 715A along a document path defined by one or more guides 780-782. As document 715A approaches an imaging roller 770, a position of document 715A may be detected by one or more sensors 745 that detect the presence of document 715A. For example, sensor 745 may be an optical sensor and configured to detect passage of a first predefined position within chassis 710 of an anterior edge 715A₁ of document 715. Sensor 745 may be coupled to one or more DC motors 765 operable to impart a rotational motion to imaging roller 770 that facilitates engagement of the document and drives the document past elongate opening 745. DC motor 765 may be operable to impart a reciprocating translational motion to imaging roller 770 as well. Reciprocal translation of imaging roller 770 between a first position and a second position disposed vertically therebelow may be achieved by, for example, a cable and rotatable pulley coupling powered by a reversible DC motor and initiation of translation from a first position to a second position may be made upon detection of anterior edge 715A₁ passing the first predefined position and is preferably timed so that an anterior edge 715A₁ of document 715A passes through scan region 725 and impinges guide 781 prior to engagement of imaging roller 770 with document 715A. Moreover, it is preferable that guide 780 provides a vertex 780A situated at a greater vertical disposition than another vertex 781A provided by guide 781 relative to a platen surface 110A. Exemplary vertices 780A and 781A are formed at a structural intersection of guide 780 with bottom surface 735 and a structural intersection of guide 781 with bottom surface 735. Accordingly, document 715A may be driven along the feed path defined by guide 780 and imparted into scan region 725 with sufficient trajectory that anterior edge 715A₁ passes through scan region 725 and impinges guide 781 without contacting platen surface 110A. Thus, a common cause of jamming of a document with a vertex or other edge of a document guide is averted. Upon detection of document 715A, sensor 745 may provide an electrical signal to motor 765 and, thereafter, motor 765 may perform a first actuation of one or more linkages, gears, transmission drives or other physical couplings such that a translational motion is imparted upon imaging roller 770 that directs imaging roller toward elongate opening 745 aligned along a transverse axis 755 in bottom surface 735 of chassis 710. Actuation of any translational motion imparted to imaging roller 770 may be timed such that a portion of document 715A has traversed at least a portion of scan region 725 so that anterior edge 715A₁ has traversed scan region 725 (and thus elongate opening 745) and impinged a guide 781, or other structure, prior to engagement therewith by imaging roller 770. Thereafter, physical engagement between imaging roller 770 and a portion of document 715A intermediate anterior edge 715A₁ and posterior edge 715A₂ is made. Accordingly, upon completion of the first actuation, imaging roller 770 is positioned such that a portion of document 715 at least partially disposed within scan region 725 will abut platen 110 of reflective scanner 100 physically adjacent bottom surface 735 of ADF 700. Sensor 745 may be configured to detect passage by a second predefined position within chassis 710 of a posterior edge 715A₂ of document 715A and, upon detection thereof, convey such detection to motor 765. The second predefined position may be identical to, or disposed at a different position, within chassis 710 respective the first predefined position. Thereafter, motor 765 may impart a translational motion to imaging roller 770 such that imaging roller 770 is returned to the first vertical position from the second vertical position.

An output tray 740, or another support for receiving the document after the document is driven past elongate opening 745 may be disposed within chassis 710, or on a surface thereof, for reception of a scanned document. An output roller 795 may be rotationally engageable with document 715A and facilitate delivery thereof into output tray 740. Output roller 795 may be disposed within chassis in a position such that engagement with document 715A is performed upon traversal of anterior edge 715A₁ past elongate opening 745.

As described, a system and method for automatically feeding documents to a scanning device is provided. The device of the present invention does not comprise a scan window, or other transparent structure, and accordingly is not subject to scan quality degradation as is common in conventional automatic document feeders. Furthermore, the device may be integrated within a scanner cover assembly and does not require inclusion of a separate window for facilitating scanning by the automatic document feeder. Moreover, the technique of the present invention for feeding documents comprises positioning two guide structures in such a manner so that a trajectory imparted to a document through a scan region may be sufficient to ensure that an anterior edge of the document does not come into contact with the scanner platen, thereby avoiding a common cause of document jamming.

What is claimed is:

1. A device for feeding documents to be scanned to a scanning device, comprising:
a device chassis having an elongate opening aligned along a transverse axis of the device, the elongate opening disposed on a bottom surface of the device chassis and adjacent a platen surface when the device is positioned for performing a scan operation;
a first guide that provides at least a portion of a document feed path, the first guide comprising a first surface defining a first vertex;
a second guide that provides at least a portion of the document feed path, the second guide comprising a second surface defining a second vertex, the first vertex disposed at a greater distance than the second vertex relative to the platen surface; and
an imaging roller rotationally operable to engage a document and drive the document past the elongate opening into impingement with the second guide, the document having an anterior edge that is driven past the first vertex prior to traversing the second vertex and impinging with the second guide, the imaging roller imparting the document with a sufficient trajectory such that the anterior edge does not impinge the platen surface.

2. The device according to claim 1, further comprising:
a support for the document to be fed by the device; and
at least one feed roller for extracting the document from at least one document from the support.

3. The device according to claim 1, further comprising a second support for receiving the document after the document is driven past the elongate opening.

4. The device according to claim 1, wherein the imaging roller is reciprocally translatable between a first position and a second position.

5. The device according to claim 4, wherein the second position has a lower vertical location within the chassis with respect to the first position.

6. The device according to claim 4, wherein a translation of the imaging roller from the first position to the second position is initiated upon an anterior edge of the document traversing a first predefined position within the device.

7. The device according to claim 4, wherein a translation of the imaging roller from the second position to the first position is initiated upon a posterior edge of the document traversing a second predefined position within the device.

8. The device according to claim 1, further comprising at least one sensor operable to detect traversal of the anterior edge of the document past the first predefined position and traversal of the posterior edge of the document past the second predefined position.

9. The device according to claim 8, wherein the first predefined position and the second predefined position are identical.

10. The device according to claim 3, further comprising an output roller operable to rotationally engage the document after traversal of an anterior edge thereof past the elongate opening, engagement of the document by the output roller facilitating translation of the document to the second support.

11. The device according to claim 4, wherein the imaging roller engages the document upon translation from the first position to the second position.

12. The device according to claim 11, wherein an initial contact between the imaging roller and the document is made at a position of the document intermediate the anterior edge and a posterior edge of the document.

13. The device according to claim 4, wherein the imaging roller contacts the document after initiation of translation from the first position to the second position, the document driven into adjacent abutment with the platen by contact with the roller.

14. The device according to claim 1, wherein the at least one feed roller, the device chassis, the first and second guides, and the imaging roller are integrated within a scanner cover hingedly attached to a scanner apparatus.

15. The device according to claim 1, wherein the elongate opening corresponds to a scan region when the device is optically coupled to the second device.

16. A method of feeding a document to be scanned to a scanning device from a document feed device, comprising:
picking a document from an input support;
driving the document through traversal of a first portion of a feed path defined by a first guide, the document comprising an anterior edge, a posterior edge, and an intermediate portion therebetween;
traversing, by the anterior edge, a scan region defined by an opening in the feed device optically coupled with the scanning device, the document traversing the scan region without impinging a plane of the opening;
impinging the anterior edge with a second guide; and
driving the document through traversal of a second portion of the feed path defined by the second guide.

17. The method according to claim 16, wherein driving the document through traversal of a first portion further comprises engaging the document with a feed roller, the feed roller operable to rotationally engage the document.

18. The method according to claim 16, wherein traversing a scan region further comprising impacting the document with an imaging roller rotationally engageable with the document.

19. The method according to claim 18, further comprising reciprocally translating the imaging roller between a first position and a second position.

20. The method according to claim 19, wherein reciprocally translating the imaging roller further comprises initiating a translation of the imaging roller from a first position to a second position upon detection of passage of the anterior edge of the document past a predefined position.

21. The method according to claim 19, wherein reciprocally translating the imaging roller further comprises initiating a translation of the imaging roller from a second position to a first position upon detection of passage of the posterior edge of the document past a predefined position.

22. The method according to claim 18, wherein impacting the document with an imaging roller further comprises impacting the document with the imaging roller in the intermediate portion of the document.
